(19) United States
(12) Patent Application Publication
(10) Pub. No.: US 2009/0112505 A1
(43) Pub. Date: Apr. 30, 2009

(54) Method and system for providing test and measurement guidance

(76) Inventors: Glenn R. Engel, Snohomish, WA (US); Glen L. Purdy, JR., Snohomish, WA (US); Jefferson B. Burch, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/977,664

(22) Filed: Oct. 25, 2007

(51) Int. Cl. G01D 21/00

(52) U.S. Cl. 702/123

(57) ABSTRACT

A method for providing a user with test and measurement guidance includes collecting an inventory of available test instruments, providing data for a device under test, providing a test specification, and generating a set of tests to be performed on the device under test utilizing the inventory, data, and test specification.

### BACKGROUND

The disclosed exemplary embodiments are related to providing guidance for test and measurement operations.

A test system may include a large number and wide variety of test instruments. A user may assemble a test system by choosing specific instruments from among a set of test system components for a particular test. Other systems may be assembled for performing a variety of different tests. In some instances a test system user may not be familiar with all the capabilities of each instrument and may require guidance in assembling and interconnecting test instruments and in selecting and performing appropriate tests.

It would be advantageous to provide a user with assistance in choosing tests and measurements and in configuring a test system for performing tests and measurements.

### SUMMARY

The disclosed embodiments are directed to a method for providing a user with test and measurement guidance including collecting an inventory of available test instruments, providing data for a device under test, providing a test specification, and generating a set of tests to be performed on the device under test utilizing the inventory, data, and test specification.

The disclosed embodiments are also directed to a module for providing a user with test and measurement guidance including a memory device for storing a test system inventory and metadata and a test specification for a device under test, and a processor operable to analyze the test system inventory, metadata and test specification, and determine a set of tests and measurements that may be performed on the device under test.

In addition, a system is disclosed having a test system with one or more test instruments for testing a device, and a module connected to the test system through a network, the module including, a memory device for storing a test system inventory and metadata and a test specification for a device under test, and a processor operable to analyze the test system inventory, metadata and test specification, and determine a set of tests and measurements that may be performed on the device under test.

### BRIEF DESCRIPTION OF THE DRAWINGS

The foregoing aspects and other features of the presently disclosed embodiments are explained in the following description, taken in connection with the accompanying drawings, wherein:

FIG. 1 shows a block diagram of an exemplary test system suitable for practicing the disclosed embodiments;

FIG. 2 shows a block diagram of a configuration module according to the disclosed embodiments;

FIG. 3 shows a flow diagram of exemplary operations of the disclosed embodiments;

FIG. 4 shows a block diagram of a system according to the disclosed embodiments; and

FIG. 5 shows another diagram of a system according to the disclosed embodiments.

### DETAILED DESCRIPTION

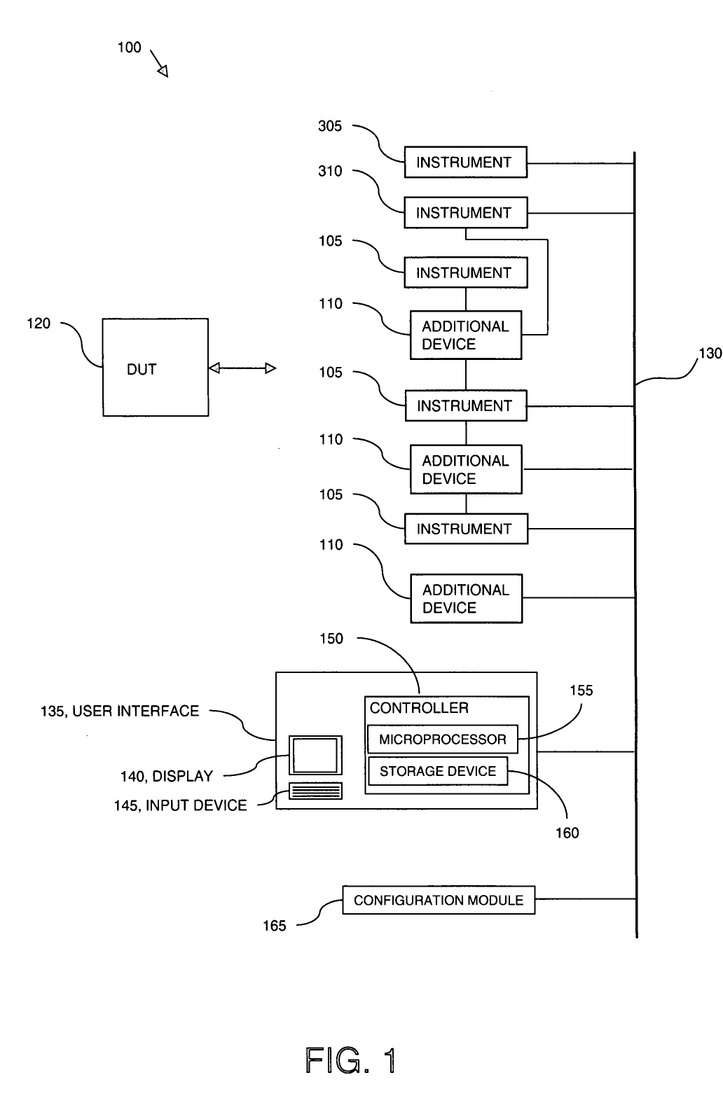

FIG. 1 shows a block diagram of a test system 100 suitable for practicing the embodiments disclosed herein. Although the presently disclosed embodiments will be described with reference to the drawings, it should be understood that they may be embodied in many alternate forms. It should also be understood that In addition, any suitable size, shape or type of elements or materials could be used.

The disclosed embodiments include a capability for analyzing a test system and assisting a user with test selection and test system configuration.

The test system 100 may include one or more test instruments 105, for example, one or more stimulators, drivers, receivers, analyzers, etc. The one or more instruments 105 may provide one or more test patterns, also referred to as test vectors, for obtaining measurements from a device under test (DUT) 120. The test patterns may include digital, analog, optical, or any suitable type of test signal. The one or more test instruments 105 may provide the signals to the DUT 120 through a hardware interface, for example, using one or more cables, an air interface, for example, using a broadcast transmission, or any other conveyance suitable for providing signals to the DUT 120.

When the test patterns are provided to the DUT 120, the DUT in return provides response signals, such as digital, analog, optical, or any types of signals. The response signals may be different in form from the test patterns, for example, a combination of analog and optical signals may result in the DUT producing digital signals as a response. One or more test instruments 105 acting as a receiver may operate to analyze the response signals from the DUT 120 or to convey them to other instruments operating as analyzers. The instruments operating as analyzers may evaluate the DUT's responses to the test patterns and may provide an indicator, for example one or more signals, of the evaluation. The indicators may simply include a measurement of the DUT's response, a comparison of the DUT's response with an expected response, a pass/fail indication, an analysis of the DUT's response with specific component failures, or any other suitable analysis of the DUT response.

In some embodiments a test instrument 105 may perform a specialized or dedicated type of stimulus function or provide a specific type of signal, as in the example of a frequency generator, or may provide a specialized or dedicated analysis function, as in the example of an oscilloscope or waveform analyzer. The test system 100 may include any combination of instruments 105, and may be modular and scalable so that necessary test system components may be assembled together as required.

The test instruments may be interconnected in various combinations, or in some embodiments may be connected by a common bus 130 for communication with each other. The test system may include additional devices 110 for example, DUT interfaces, cables, switch boxes, filters, mixers, switching matrices, etc. The additional devices 110 may provide interconnections among the one or more instruments 105 or may provide additional test and measurement functionality for the test system 100. One or more of the additional devices may also be connected to the common bus 110.

The test system 100 may also include a user interface 135. The user interface may be a separate component of the test system 100 or may be incorporated as part of one or more instruments 105. The user interface 135 may include a display 140, at least one input device 145, and a controller 150. The display 135 may utilize LCD, flat panel, plasma, or any other type of suitable technology. The at least one input device 145 may include one or more buttons, a keypad, keyboard, a pointing device such as a mouse or trackball, etc. for selecting a number of options and embellishments of a product as will be described below. The controller 150 may include a microprocessor 155 or other appropriate circuitry for controlling the operations of the user interface. The controller 150 may also include a storage device 160 embodied as a computer readable medium that generally stores machine readable program code which is adapted to cause the controller to perform the functions of the disclosed embodiments. The storage device 160 may utilize optical, magnetic, semiconductor, electronic, or other types of suitable devices to store the program code. The user interface 135 may support a browser, such as Firefox or Internet Explorer, for example, Other examples of a user interface may include a consumer computing device such as a personal digital assistant (PDA), cellular telephone, desktop, laptop, notebook, etc. The user interface 135 may include any computing device capable of providing the functions described herein.

The test system 100 may also include a configuration module 165 for analyzing the test system and assisting a user with test selection and test system configuration. In one embodiment, the configuration module 165 may be provided, or retrofitted, as a modular component on the bus 130. The configuration module 165 may also be distributed among any combination of the test instruments 105 or additional devices 110, or integrated as part of the user interface 135. The configuration module 165 may be implemented using any combination of hardware and software. For example, in some embodiments the configuration module 165 may be implemented as test controller, for example, a computer workstation. In other embodiments the configuration module 165 may be implemented as circuitry installed in the test system 100. In still other embodiments the configuration module 165 may be implemented as a software downloadable that runs in a browser, or as a program installed in storage device 160 or any other memory device of the test system 100. In still further embodiments, the configuration module 165 may be implemented as a software program or product stored on a computer readable medium, for executing the disclosed embodiments when run on a data processing system, for example the processors and memory or storage devices as disclosed. The computer readable medium may include any optical, magnetic, semiconductor, electronic, or other medium suitable for use with a data processing system.

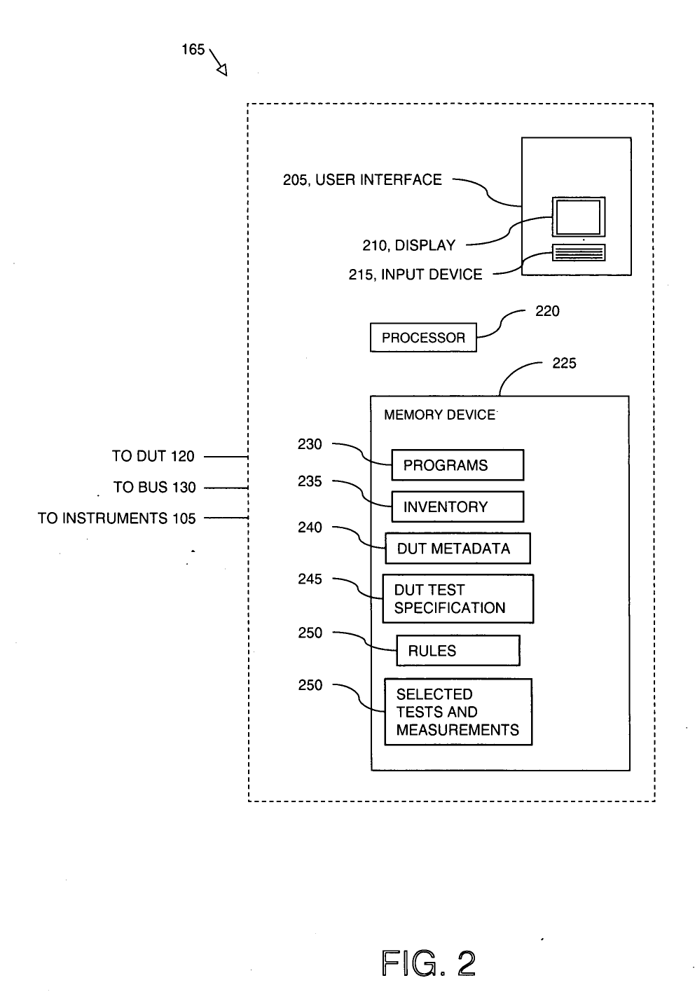

FIG. 2 shows an exemplary implementation of the configuration module 165 in greater detail. The configuration module 165 may include its own user interface 205, including for example, a display 210 and input device 215, a processor 220 and a memory device 225. The processor 220 may operate under control of programs 230 to perform test system analysis, test selection, and test system configuration operations according to the disclosed embodiments. The programs 230 may be embodied on a computer readable medium, for example, memory device 225. The memory device 225 may store tables, databases or other information related to the test system 105, the DUT 120, or provided by users. The memory device 225 may include magnetic, optical, semiconductor, or any other type of computer readable storage medium. The configuration module 165 may be connected directly to the instruments 105 or may be connected to the instruments through bus 130. The configuration module 165 may also have a connection to the DUT.

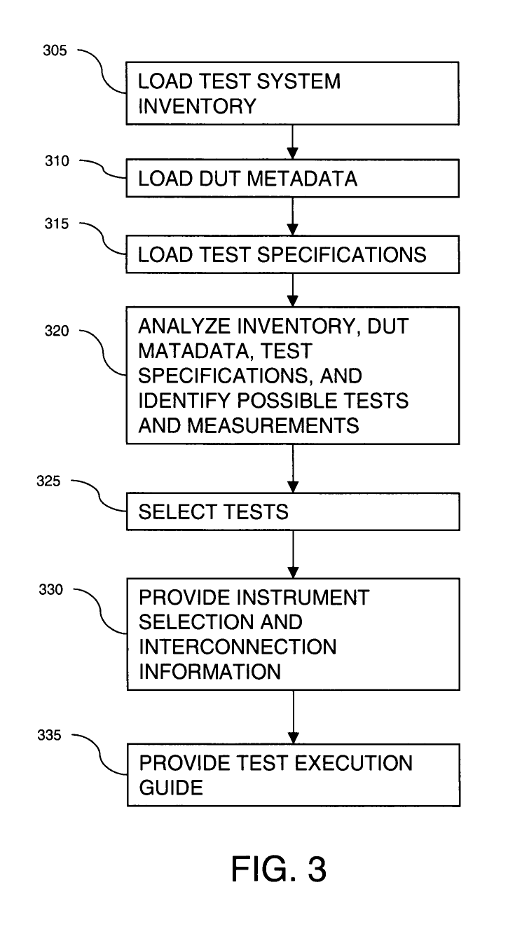

Exemplary operations of the disclosed embodiments will now be described while referring to FIGS. 2 and 3. An inventory 235 of the test system 105 may be loaded into the configuration module 165 and stored in memory device 225 as shown in block 305. The inventory 235 may be loaded manually by a user, for example through the user interface, or the configuration module 165 may interrogate the test system 105 to discover the test system's components. In at least one embodiment, one or more of the instruments 105 and the additional devices 110 may supply a signal that provides the inventory information and may be used to identify interconnections among the test system components. Other instruments and additional components as well as the configuration module 165 may sense the signal and utilize it to identify interconnections with other components and the characteristics of those components. The inventory 235 may generally include information about each of the instruments 105 including their capabilities, information about each of the each of the additional devices 110 and their capabilities, and the interconnections among the instruments 105 and additional devices 110. The inventory may be updated when required. DUT metadata 240 may also be loaded into the configuration module 165 as shown in block 310. The DUT metadata 240 generally includes information about the design and operation of the DUT and may include circuit descriptions, interconnections among circuits within the DUT, operational specifications, computer aided design files, simulation files, etc. Similar to the inventory 235, the DUT metadata 240 may be loaded manually or the configuration module 165 may interrogate the DUT 120. A DUT test specification 245 may also be loaded into the configuration module 165 as shown in block 315. The test specification 245 may be detailed or general depending on, for example, a user's requirements. In some instances, the test specification may include specific measurements to be performed on the DUT, the expected results, and further actions to be taken depending on the results. In other instances, a user may simply specify a required test by name in the test specification and the configuration module 165 may provide the specific operations required. While the test specifications 245 may generally be provided by a user, the configuration module 165 may be capable of generating test specifications from the DUT metadata 240 and optionally in combination with the test system inventory 235. The configuration 165 module may also be loaded with a set of standard or pre-defined test specifications for certain DUT's or DUT circuits.

As shown in block 320, the configuration module 165 may operate to analyze the test system inventory 235, DUT metadata 240, and test specifications 245 to determine a set of tests and measurements that may be performed on the DUT 120. Tests and measurements from the determined set may be selected for use with the DUT 120 as shown in block 325. The tests and measurements may be selected by the user or may be selected automatically under program control using a set of rules 250 stored in memory 225. The selected tests and measurements 255 may be stored in memory 225. In some embodiments, the user may modify one or more of the selected tests and measurements as required and the modified tests and measurements may also be stored in memory 225. The configuration module 165 may then utilize the selected tests and measurements 255 to provide instrument selection and interconnection information as shown in block 330. The instrument selection and interconnection information may include instruments required for the selected tests and measurements and interconnections among the instruments that may be necessary. In some embodiments, the instrument selection and interconnection information may be provided to the user and the user may interconnect the selected instruments and the DUT according to the information provided. In other embodiments instrument selection and interconnection may be performed by the configuration module under program control. As shown in block 335, the configuration module 165 may also provide the user with a test execution guide to guide the user through the testing process.

In some embodiments, during the exemplary operations the configuration module 165 or the user may identify a new test or measurement requirement. The instruments 105 and additional devices 110 required for the new requirement may be obtained and added to the inventory 235.

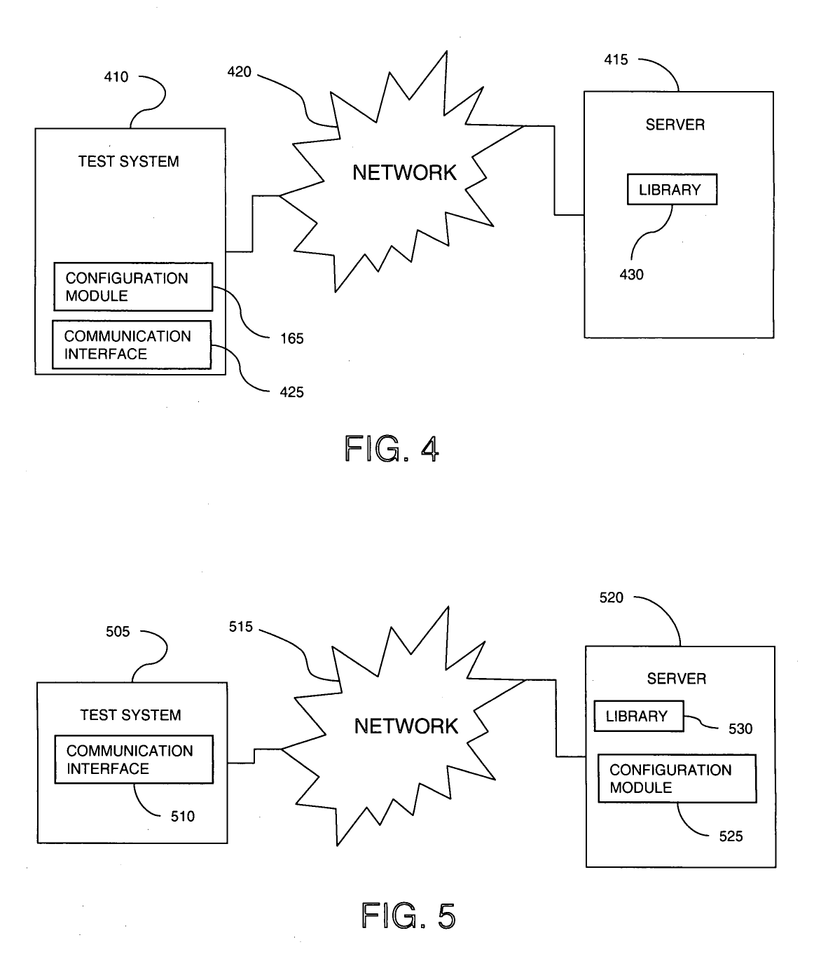

FIG. 4 shows another exemplary system 400 for practicing the disclosed embodiments. System 400 includes one or more test systems 410 connected to a server 415 through a network 420. The test systems 410 may be similar to test system 100 described above and may include a configuration module 165 as described above and a network communication interface 425 for communicating with the server 415. The network 420 may include any suitable communications network, for example, the Public Switched Telephone Network (PSTN), a wireless network, a wired network, a Local Area Network (LAN), a Wide Area Network (WAN), a virtual private network (VPN) etc. Communication between the one or more test systems 410 and the server 415 may be achieved using any suitable protocol or modulation standard, for example, X.25, ATM, TCP/IP, V34, V90, etc. Network 115 may also include a wireless network with an air interface utilizing any suitable wireless communication protocol or signaling techniques or standards, for example TDMA, CDMA, IEEE 802.11, Bluetooth, close range RF, optical, any appropriate satellite communication standards, etc. In at least one embodiment, the server 415 may provide a library 430 for use by any number of configuration modules 165 connected through network 420. The library may include a listing of test instruments 105 and additional devices 110, their capabilities, and other information that may be used as part of a test system inventory 235. The library 430 may also include DUT metadata for predefined DUT's or circuitry or functions that may be included in a DUT. Test specifications and tests and measurements to be utilized by a configuration module may also be included in the library 430. The library 430 may be updated when required, for example to provide additional test instrument information, additional test specifications, tests and measurements, etc. During operations, a configuration module 165 may access the library 430 for information which may include inventory information, DUT metadata, test specifications, tests, measurements, or any other information that may be available in the library 430.

FIG. 5 shows another system 500 according to the disclosed embodiments. System 500 includes one or more test systems 505 connected to a server 520 through a network 515. The test systems 505 may be similar to test system 100 described above and may include a network communication interface 510 for communicating with the server 520. In this embodiment, the server includes a configuration module 525 and a library 530. The configuration module 525 provides all the functionality of the configuration module 165 described above, but from a central server 520 as opposed to an installed component of a test system. The library 530 may include all the information of library 430 described above and may be updated and accessed in a similar fashion. In some embodiments, the server 520 may operate as a web portal, accessible through a browser of the tests system 505.

As can be seen, with characteristics of a test system, information about a DUT, and test specifications, the disclosed embodiments perform an analysis of the information and provide a test system user with a set of tests and measurements that may be performed on the DUT, instrument selection and interconnection information, and test execution guidance.

It should be understood that the foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the appended claims.

What is claimed is:

1. A method for providing a user with test and measurement guidance comprising:
collecting an inventory of available test instruments;
providing data for a device under test;
providing a test specification; and
generating a set of tests to be performed on the device under test utilizing the inventory, data, and test specification.

2. The method of claim 1, further comprising collecting an inventory of available test instruments by automatic communication or signal sensing.

3. The method of claim 1, further comprising collecting an inventory of available test instruments by manual input.

4. The method of claim 1, wherein the data for the device under test includes information about the design and operation of the device under test.

5. The method of claim 4, wherein the information about the design and operation of the device under test includes one or more of circuit descriptions and interconnections among circuits within the device under test.

6. The method of claim 1, further comprising generating a set of tests to be performed on the device under test by:
determining a set of tests and measurements that may be performed on the device under test;
selecting tests and measurements from the determined set; and
providing instrument selection and interconnection information from the selected tests and measurements.

7. A software program or product stored on a computer readable medium, for executing the method of claim 1, when run on a data processing system.

8. A module for providing a user with test and measurement guidance comprising:
a memory device for storing a test system inventory and metadata and a test specification for a device under test; and
a processor operable to analyze the test system inventory, metadata and test specification, and determine a set of tests and measurements that may be performed on the device under test.

9. The module of claim 8, wherein the processor is further operable to collect an inventory of available test instruments by automatic communication or signal sensing.

10. The module of claim 8, wherein the processor is further operable to collect an inventory of available test instruments by receiving manual input from a user.

11. The module of claim 8, wherein the metadata for the device under test includes information about the design and operation of the device under test.

12. The module of claim 11, wherein the information about the design and operation of the device under test includes one or more of circuit descriptions and interconnections among circuits within the device under test.

13. The module of claim 8, wherein the processor is further operable to select tests and measurements from the determined set and to provide a user with instrument selection and interconnection information.

14. A system comprising:
a test system having one or more test instruments for testing a device; and
a module connected to the test system through a network, the module including:
a memory device for storing a test system inventory and metadata and a test specification for a device under test; and
a processor operable to analyze the test system inventory, metadata and test specification, and determine a set of tests and measurements that may be performed on the device under test.

15. The system of claim 14, wherein the processor is further operable to collect an inventory of available test instruments by automatic communication or signal sensing.

16. The system of claim 14, wherein the processor is further operable to collect an inventory of available test instruments by receiving manual input from a user.

17. The system of claim 14, wherein the metadata for the device under test includes information about the design and operation of the device under test.

18. The system of claim 14, wherein the information about the design and operation of the device under test includes one or more of circuit descriptions and interconnections among circuits within the device under test.

19. The system of claim 14, wherein the processor is further operable to select tests and measurements from the determined set and to provide a user with instrument selection and interconnection information.
